(19) United States
(12) Patent Application Publication
(10) Pub. No.: US 2002/0146139 A1
(43) Pub. Date: Oct. 10, 2002

(54) Multi-channel speaker system integrated into a combination television stand and audio/video equipment cabinet

(76) Inventor: Terry R. Oplinger, Clinton Township, MI (US)

Correspondence Address: Robin W. Asher, Clark Hill PLC, 500 Woodward Aveue, Suite 3500, Detroit, MI, 48226-3435, US

(21) Appl. No.: 09/834,092

(22) Filed: Apr. 12, 2001

Related U.S. Application Data
(63) Continuation-in-part of application No. 08/861,102, filed on May 21, 1997, now abandoned.

(51) Int. Cl. H04R 5/02

(52) U.S. Cl. 381/300; 381/306; 381/307

(57) ABSTRACT

A home theater system configured as a combination television stand, audio/video component cabinet, and multi-channel, multi-speaker system cabinet. Individual full range speakers or speaker systems are pre-wired to speaker terminals mounted on the cabinet and provided for transmitting a separate channel of full range of audio reproduction from separate channels of full range electrical audio signal transmitted from an amplified audio/video component. A center speaker system is mounted on an upwardly tilted panel at the top of the cabinet. Right and left front speaker systems are mounted on an outwardly angled front corner panel of the cabinet and include a tweeter and midrange loudspeaker. A woofer loudspeaker is mounted facing outwardly from at least one of the side panels of the cabinet. Finally, left and right rear surround speakers are mounted to outwardly angled panels at the rear comers of the cabinet to complete the five channel speaker system.

### BACKGROUND OF THE INVENTION

1. Field of Invention

The present invention relates to a multi-channel speaker system, or home theater system. More particularly, the present invention relates to a multi-channel speaker system integrated into a combination television stand and audio/video equipment cabinet.

2. Description of the Related Art

Home theater systems integrated into a listeners home are becoming increasing popular for providing full audio and video playback of movies, music, concerts, and the like, available from such sources as videotapes, laser discs, television/cable/satellite broadcasts, and most recently DVD discs. A home theater system typically includes a video source such as VCR and/or DVD player and a television or projection monitor; an audio source such as a receiver, amplifier, CD player, and/or DVD player; and an audio output source such as an audio speaker or plurality of audio speakers. The audio signal may originate from the audio source in one of two basic configurations. One configuration includes two signals with are encoded for matrixing into multi-signals. The other configuration includes six discrete (separate and independent) signals which include five full range and one low range frequency signal. With either configuration, the signals are sent to an audio receiver or amplifier which then delivers up to five full range channels of audio signals to the speaker systems.

The typical arrangement for reproduction of the audio includes separate full range speakers or speaker systems as follows and as shown in prior art FIG. 1:

1. A center channel speaker located in a position which is generally horizontally aligned with screen of the television;

2. A right and left front speaker positioned to each side of the television; and

3. A left and right rear surround speaker positioned to the side or rear of the listener/viewer.

Each of the speakers must be independently connected to the audio receiver or amplifier and properly positioned in the room for proper acoustics. This arrangement requires substantial setup effort and the speakers, and speaker wires, are often difficult to hide or integrate into the room decor and furnishings.

Each speaker, or speaker system, may include one or more loudspeakers, or drivers, for reproducing sound within a predetermined frequency range. That is, the speakers may include a tweeter for reproducing sound from a high frequency range, a mid-range for reproducing sound from a mid frequency range, and a woofer for reproducing sound from a low frequency range. The drivers are interconnected by electrical wires and joined at a terminal for connection to the audio source.

The audio source is commonly capable of producing a plurality of channels of sound which may be directed to one of the speakers. For example, the audio source may produce five full channels of sound: a left channel directed to the left front speaker, a right channel directed to the right front speaker, a center channel directed at the center speaker, and a rear channel directed to each of the rear surround speakers. This configuration is commonly referred to as “Dolby Surround” sound. The audio source may also produce a separate channel of low frequency which may be directed to a separate sub-woofer. Additionally, the audio source may also produce separate left and right rear channels directed to the respective left and right rear surround speakers. This latter configuration is commonly referred to as “Dolby Digital” sound. Each channel of sound is associated with a speaker terminal on the audio source for connection to one of the independent speakers. That is, the audio source may include a left front speaker terminal, right front speaker terminal, left rear surround speaker terminal, right rear surround speaker terminal, and center speaker terminal. Each speaker terminal includes a positive and negative connector. Each speaker, in turn includes a speaker terminal including a positive and negative connector. Therefore, the corresponding speaker terminals from the audio source must be connected by speaker wire to the corresponding speaker terminals on each independent speaker.

There have been efforts to provide a single cabinet with speakers capable of reproducing more than two channels of sound, i.e. left channel and right channel (stereo), as for example the system described in U.S. Pat. No. 5,533,129 issued on Jul. 2, 1996 for a “Multidimensional Sound Reproduction System”. See also the advertisement for the “Mission M-Time”, page 15 of Stereo Review, February 1996.

Such efforts, however, have not received full range line input signals for each channel and reproduced the same amount of separate acoustic channels of output unchanged. This would require a separate and dedicated full range speaker or speaker system for each channel within the cabinet. Instead, these prior efforts can be characterized in two categories:

Category 1: Separate line input signals received for each channel are changed by altering or combining the signal with other signals. Acoustic channels of output either differ in number or sound from the input. For example, the '129 patent disclosed above produces only three acoustic channels of output.

Category 2: Separate line input signals received with one channel fully reproduced as received and the others partially reproduced requiring additional external speakers, or speaker systems, to reproduce the remaining sound. For example, the “Mission M-Time” disclosed above produces only one full range channel of output (the center channel) with the other two channels combined and reproduced in partial range.

Therefore, it is desirable to provide a multi-channel speaker system, or home theater system, which is capable of receiving three or more separate and discrete channels of full range audio input signals and reproducing the equivalent amount of full range acoustic channels of output, all emanating from the same cabinet.

### SUMMARY OF THE INVENTION

The present invention includes a home theater system comprising a combination television stand and audio/video equipment cabinet including a support base for supporting the cabinet and a planar top adapted to support a television. At least three speaker systems are mounted in the cabinet and configured to independently transmit a full range of audio reproduction. At least three speaker terminals are also mounted to the cabinet, wherein each of the speaker terminals is adapted to receive a separate and discrete channel of full range electrical audio signal transmitted from an amplified audio/video component. The system further includes an audio connector electrically connecting each of the speaker systems with a respective one of the speaker terminals whereby each of the separate and discrete channels of full range electrical audio signal transmitted from the amplified audio/video component is reproduced acoustically and directly from the independent speaker systems as a corresponding separate and discrete channel of full range of audio.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic diagram of a prior art home theater system;

FIG. 2 is a perspective view of a multi-channel speaker system and combination television stand and audio/video equipment cabinet according to the present invention, shown with a television set supported on the top thereof;

FIG. 3 is an schematic view of the rear of the cabinet and the connections between an audio/video component and the speaker connection terminal panel;

FIG. 4 is a plan view diagram of the sound field distribution produced by the multi-channel speaker system relative to the listening room and viewer/listener;

FIG. 5 is a perspective view of the system of FIG. 2 with the structures thereof shown in phantom to reveal the various speakers, audio/video components and speaker connection terminal panel;

FIG. 6 is an exploded perspective view of the cabinet;

FIG. 7 is a front view of the cabinet;

FIG. 8 is a side view of the cabinet;

FIG. 9 is a plan view of the cabinet;

FIG. 10 is plan view of an alternative embodiment which does not have the rear speakers installed in the cabinet;

FIG. 11 is a rear view of the speaker connection terminal panel and cross-over circuit;

FIG. 12 is an enlarged fragmentary front perspective view of the speaker connection terminal panel; and

FIG. 13 is a schematic diagram of the speaker connection terminal panel and cross-over circuit.

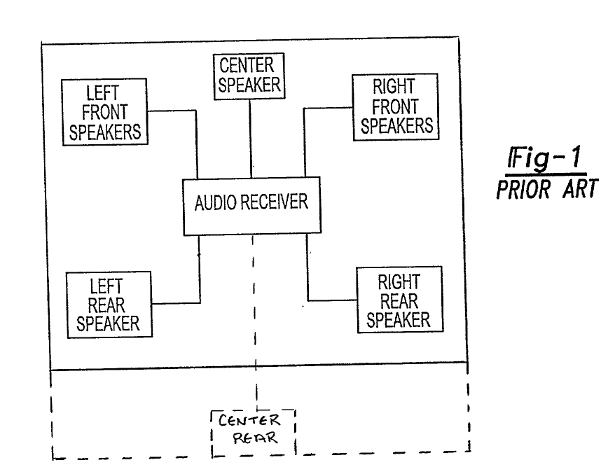

### DETAILED DESCRIPTION OF THE PREFERRED EMBODIMENT

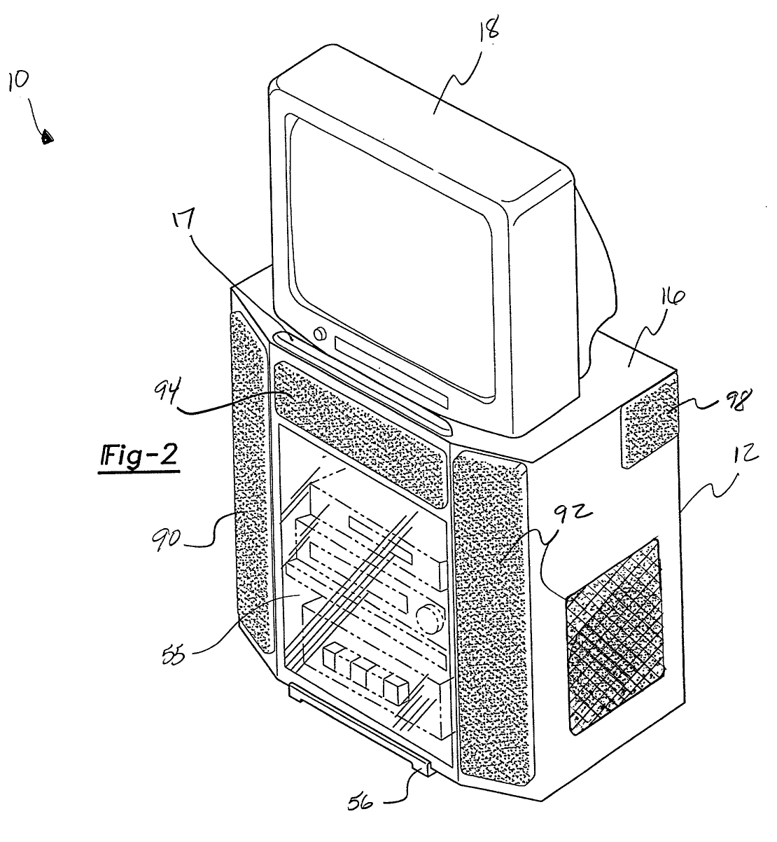

Referring to the Figures, wherein like reference numbers correspond to the same or like parts throughout the several views, a home theater system is generally shown at 10 in FIG. 2. The home theater system 10 includes a combination television stand and audio/video equipment cabinet 12 including a support base 14 for supporting the cabinet and a planar top 16 adapted to support a television or projection monitor depicted at 18. The planar top 16 includes an elongated raised rib 17 extending across the front edge thereof to prevent the television from sliding off the front of the cabinet 12.

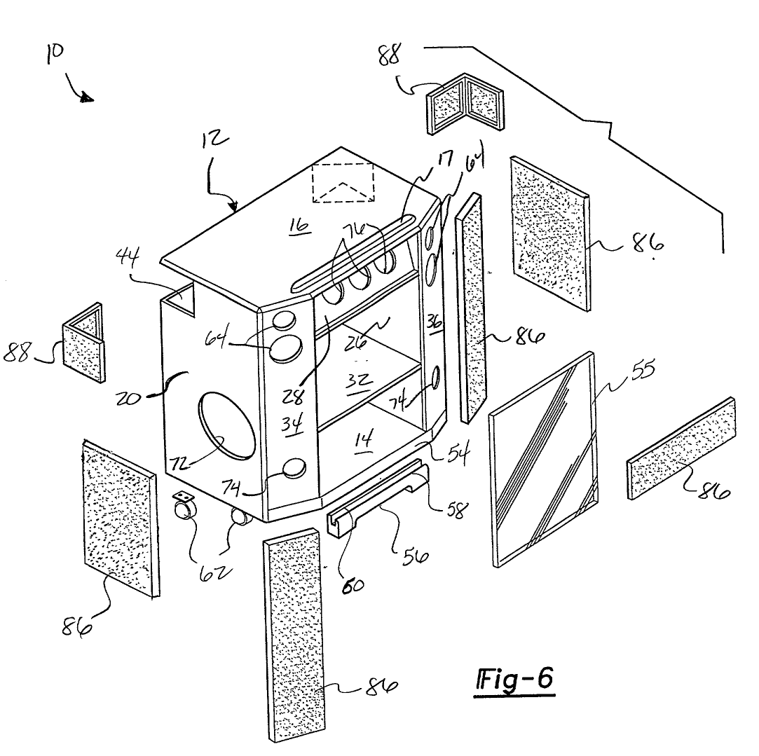

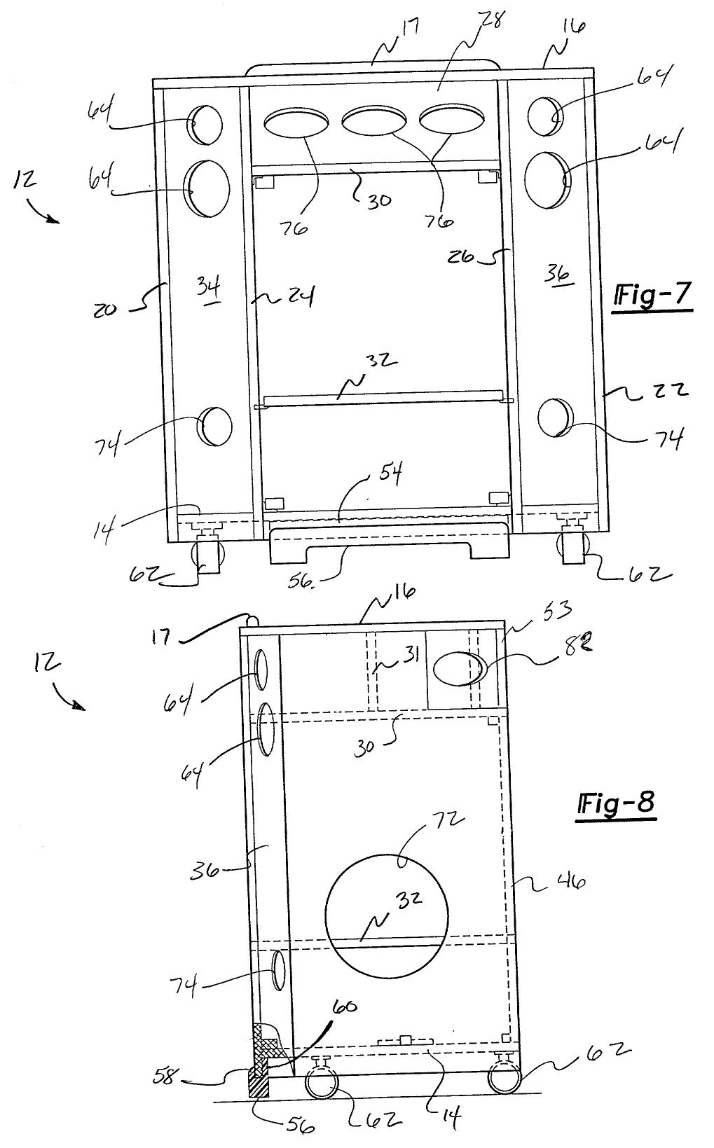

Referring specifically to FIGS. 6-10, the cabinet 12 is a generally upright box structure having spaced apart left and right side panels 20, 22 extending vertically between the support base 14 and the planar top 16. The cabinet 12 further includes left and right inner side panels 24, 26 spaced from and parallel to the respective left and right side panels 20, 22 and extending between the support base 14 and the planar top 16 and defining speaker chambers therebetween. A center front panel 28 extends between the left and right inner side panels 24, 26 adjacent the planar top 16 and spaced above the lower support base 14. A middle bottom panel 30 spaced below and parallel to the planar top interconnects the center front panel 28 and the left and right inner side panels 24, 26. A middle rear panel 31 interconnects the middle bottom panel 30 and the planar top 16 and extends between the left and right inner panels 24, 26 and defines a center cavity therebetween. The center front panel 28 is tilted upwardly or rearwardly from the front of the cabinet, however, as may be appreciated, may be flush with the front of the planar top 16 and inner panels 24, 26.

The area between the middle bottom panel 30, the support base 14 and the inner panels 24, 26 defines a storage cavity. A removable planar shelf 32 is adjustably supported between the inner panels 24, 26 by conventional means and extends between the front and rear portion of the cabinet for supporting one or more audio/video components such as an A/V receiver, amplifier, pre-amplifier, VCR, DVD player, laser disc player, cassette deck, turntable or the like, within the storage cavity. It should be appreciated that more than one adjustable/removable shelf may be provided. Additionally, a storage container may also be provided and slidably positioned within the cavity.

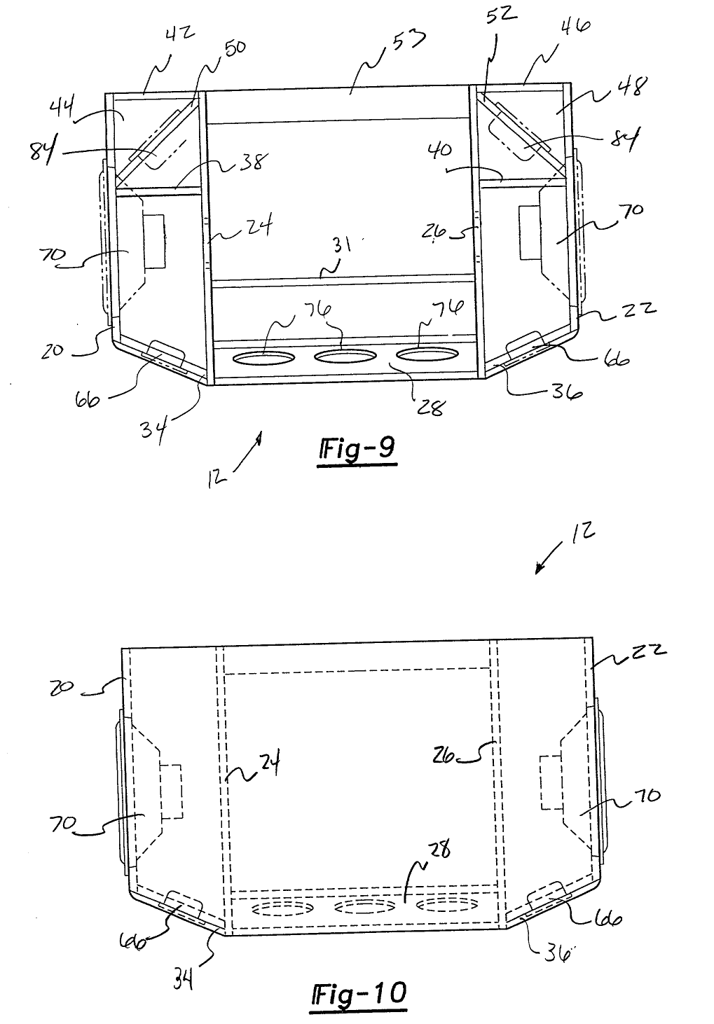

A left front panel 34 extends vertically between the support base 14 and planar top 16 and horizontally between the left side panel 20 and left inner panel 24 to close the front of the speaker chamber therebetween. Similarly, a right front panel 36 extends vertically between the support base 14 and planar top 16 and horizontally between the right side panel 22 and right inner panel 26 to close the front of the speaker chamber therebetween. The left front panel 34 and right front panel 36 are angled outwardly or face outwardly at a predetermined angle. A left inner rear panel 38 extends vertically from the support base 14 and between the left side panel 20 and left inner panel 24 to close the rear of the speaker chamber. Similarly, a right inner rear panel 40 extends vertically from the support base 14 to the and between the right side panel 22 and right inner panel 26 to close the rear of the speaker chamber. The left and right inner rear panels 38, 40 are positioned midway between the front and rear of the cabinet to separate the speaker chambers into front and rear portions as shown in FIG. 9.

A left back panel 42 extends vertically from the support base 14 and between the left side panel 20 and left inner panel 24 to a first horizontal rear shelf 44. Similarly, a right back panel 46 extends vertically from the support base 14 and between the right side panel 22 and the right inner panel 26 to a second horizontal rear shelf 48. An upright left rear corner wall 50 is positioned facing outwardly from the cabinet 12 and connected between the first rear shelf 44 and planar top 16 and diagonally between the left side panel 20 and left inner panel 24. Likewise, an upright right rear corner wall 52 is position facing outwardly from the cabinet 12 and connected between the second rear shelf 48 and the planar top 16 and diagonally between the right side panel 22 and the right inner panel 26. A top rear panel 53 extends between the right and left inner side panels 38, 40 and connects with the planar top 16. A rear door or fabric curtain may be provided and attached via fasteners, such as hook and loop tape, between the back panels 42, 46 to close the rear portion of the storage compartment. A front door, such as a tempered glass door 55, is hingedly secured to the left inner panel 24 and releasably/lockably latched to the right inner panel 26 for closing the front portion of the storage compartment while providing visibility of the component stowed therein.

A lower front facia 54 extends between the left and right front panels 34, 36 and below the support base 14 for receiving an anti-tip bracket 56. Referring to FIGS. 2 and 6-8, the anti-tip bracket 56 is an elongated U-shaped member having a front lip 58 and spaced apart and parallel rear lip 60 defining a channel therebetween. The rear lip 60 is slightly taller than the front lip 58 such that the front facia 54 may be positioned within the channel between the lips 58, 60 with the bottom surface of the bracket supported on the floor to prevent the cabinet 12 from tipping forwardly.

Referring to FIGS. 6-8, the cabinet 12 further includes a plurality of wheeled castors 62, one secured in each bottom corner of the support base 14 for supporting and providing rolling movement of the cabinet 12.

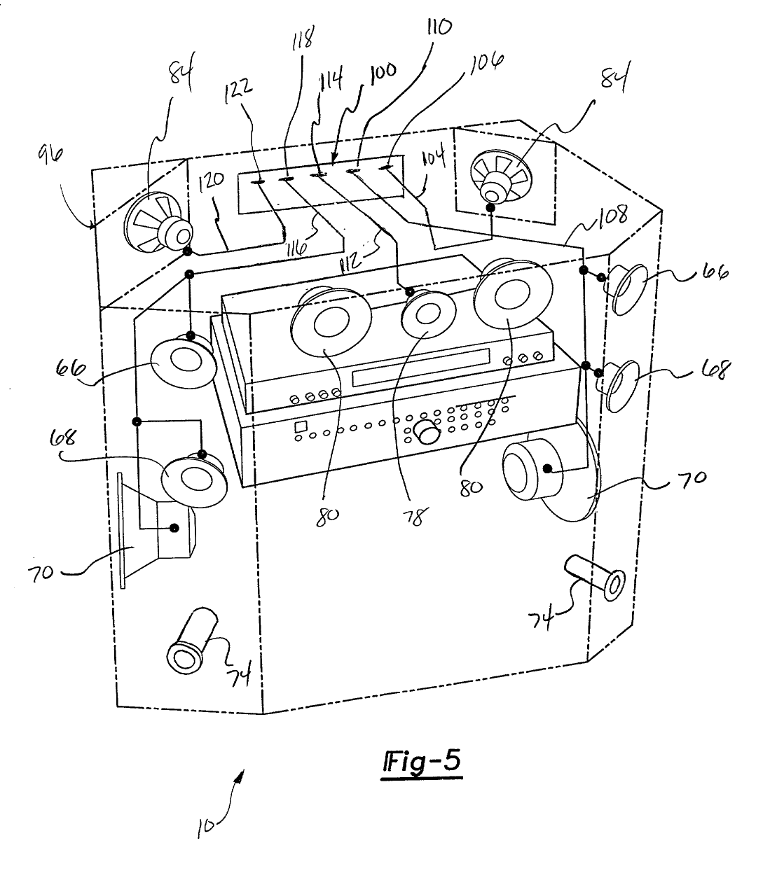

Each of the left front panel and right front panel 34, 36 include a plurality of holes 64 extending therethrough for receiving and mounting one or more speakers, or loudspeaker components of a speaker system, as shown in FIGS. 5 and 6. The speakers in the front panels 34, 36 are the left front and right front main speakers and may include a single full range loudspeaker; a tweeter and mid-range loudspeaker forming a two-way speaker system; a tweeter, mid-range and woofer loudspeaker forming a three-way speaker system or any combination thereof. In the preferred embodiment, the left front and right front main speakers are three way speakers wherein a tweeter 66 and mid-range loudspeaker 68 are mounted in the holes 64 of the left and right front panels 34, 36 and a woofer loudspeaker 70 is mounted in a hole 72 in each of the left and right side panels 20, 22. The front panels 34, 36 may also include a vent ports 74 if the system desires to utilized a vented subwoofer.

Similarly, the center front panel 28 includes a plurality of holes 76 extending therethrough for receiving and mounting one or more speakers. The speakers in the center front panel 28 are the center speakers and also may include a single full range loudspeaker, a two-way speaker system or a three-way speaker system. In the preferred embodiment, the center speaker is a two-way speaker wherein a tweeter 78 is mounted in the center hole 76 between a pair of full-range, mid-range or woofer loudspeakers 80.

Each of the left and right rear corner walls 50, 52 also include a hole 82 therethrough for receiving and mounting left and right rear surround speakers. As shown in FIGS. 5 and 9, the rear surround speakers are single full-range loudspeakers 84 mounted in the hole 82 of each wall 50, 52. However, it should be appreciated that the walls 50, 52 may include a plurality of holes for mounting a two-way or three-way speaker system similar to the front main speakers or center speaker as may be desired. Alternatively, as shown in FIG. 10, the rear surround speakers may be excluded and provided for independent of the system 10.

Referring to FIG. 6, each of the holes and speakers in the plurality of panels are covered by speaker grill covers 86, 88 which may be removably mounted to the cabinet to conceal each speaker. The grill covers 86 cover the right and left front main speakers and the center speaker and the grill covers 86 are L-shaped to cover the 90 degree corner opening of the rear surround speakers. The grill covers 86, 88 are preferable mesh or porous material to allow sound wave to travel through the covers without impedance.

Referring again to FIG. 2, each speaker system is configured to independently transmit a full range of audio reproduction received from an amplified audio/video component such as a receiver, VCR, or DVD player. That is, the left and right front main speaker systems designated at 90 and 92 are each configured to independently transmit a full range of audio. Likewise, the center speaker system 94 as well as the left and right rear surround speakers 96, 98 are also each configured to transmit a full range of audio independent of any of the other speakers.

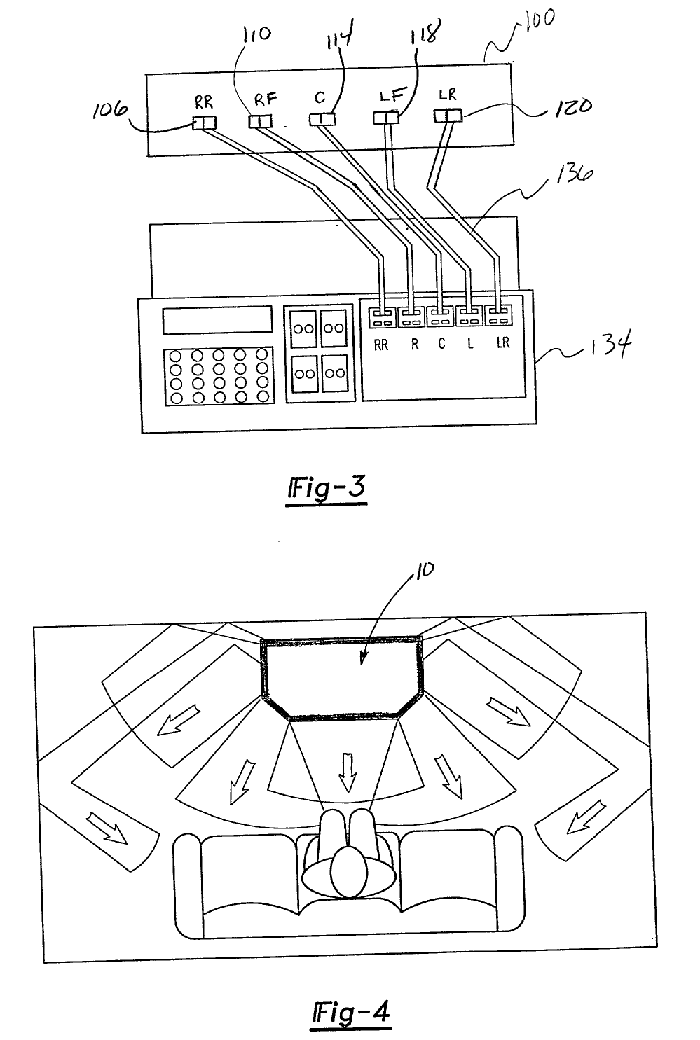

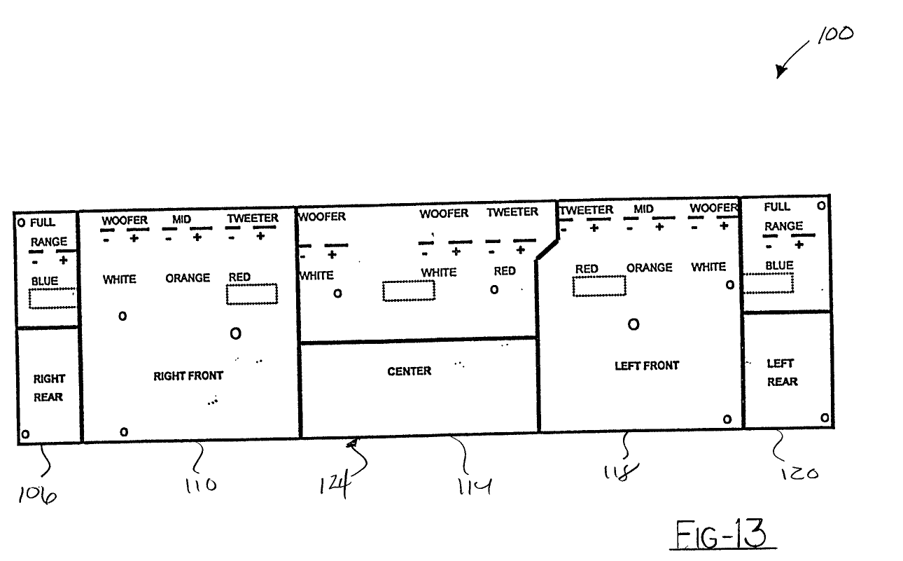

Referring now to FIGS. 3, 5 and 12 the system 10 further includes an connecting board 100 adapted to electrically interconnect each of the speaker systems, (left front, right front, center, left rear and right rear) independently to associated speaker outputs of the amplified audio/video component. More specifically, the connecting board 100 includes a panel 102 which is fixedly mounted to the top rear panel 53 of the cabinet 12. A plurality of independent speaker terminals are mounted to the panel 102. An audio connector electrically connects each of the independent speaker systems with a respective one of the independent speaker terminals. That is, a right rear connector 104 electrically interconnects a right rear speaker terminal 106 with the right rear surround speaker 98; a right front connector 108 electrically interconnects a right front speaker terminal 110 with the right front speaker system 92; a center connector 112 electrically interconnects a center terminal 114 with the center speaker system 94; a left front connector 116 electrically interconnects a left front terminal 118 with the left front speaker system 90; and a left rear connector 120 electrically interconnects a left rear terminal 122 with the left rear speaker 96. Each of the separate loudspeaker components of the a speaker system are connected in series by the audio electrical connector. For example, the tweeter 66, mid-range 68 and woofer 70 of the left front speaker system 90 are electrically interconnected in series by the left front connector 116. The audio connectors may include conventional electrically conductive wire. The terminals, as shown in FIG. 12, each include a positive and negative junction as is conventionally known.

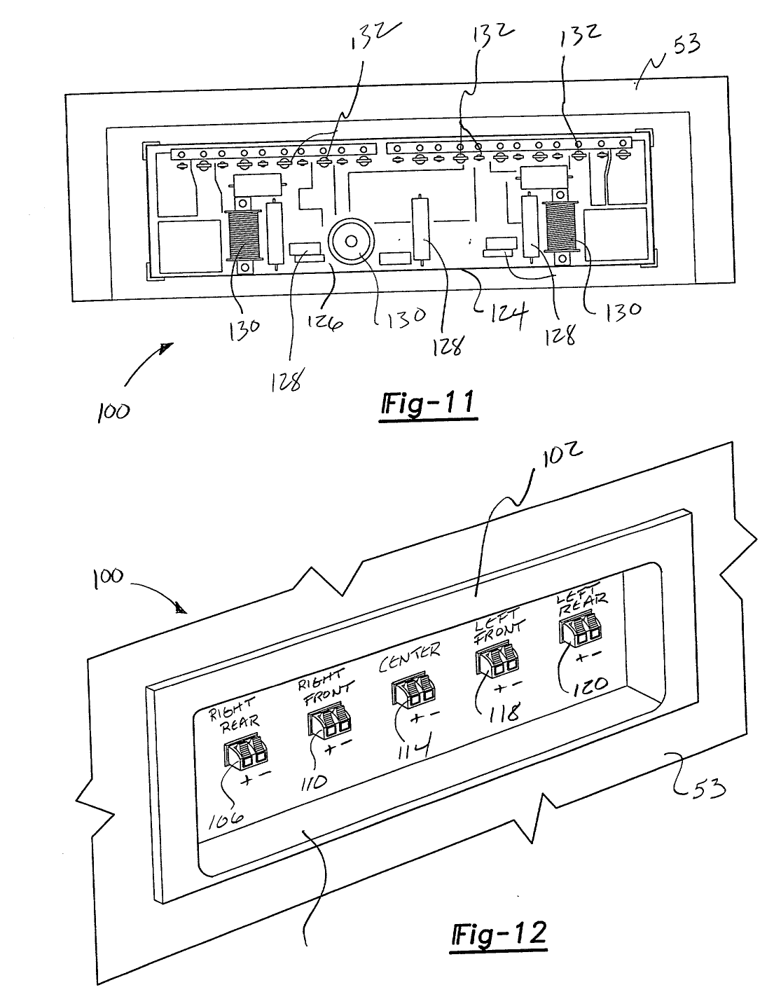

Referring to FIGS. 11 and 13, the connecting board 100 further includes a crossover circuit board 124 interconnected between said terminals and said connectors for transmitting the properly ranges of an electrical audio signal to said loudspeakers of said speaker systems. More specifically, the cross-over circuit board 124 includes an planar electrically conductive panel 126 for electrically interconnecting and supporting a one or more capacitors 128, coils 130, and posts 132 are is conventionally known in the art. Typically there is required a separate cross-over circuit board and panel for each speaker systems. The system 10 of the present invention, however, utilizes a single cross-over circuit board and panel for all of the speaker systems, and without altering, deleting or changing the electrical audio signals therebetween. Specifically, referring to FIG. 13, the left rear and right rear surround speakers 84 are full range speakers. Therefore, the connectors 104, 120 are connected directly between the positive and negative posts on the speaker 84 and the positive and negative posts on the panel 126 as shown. However, since the center speaker systems 94 is a two-way speaker system and the left and right front speaker systems 90, 92 are three-way speaker systems, a cross-over circuit must be utilized to transmit the appropriate frequency range input from the terminals 110, 114, 118 to either the tweeter 66, mid-range 68, or woofer 70 making up the speaker system. As shown in FIG. 13, the cross-over circuit board 124 essentially includes three independent cross-overs of capacitors and coils assembled on a single electrical panel 126. That is, the cross-over for the left front speaker system 90, right front speaker system 92 and center speaker system 94 is separate or independently operational, but yet they share the same electrical panel 126. This greatly reduces the number of parts, assembly and package size normally associated with separate panels and cross-over circuits.

In operation, referring to FIG. 3, the system 10 must be connected to some source or audio such as an amplified audio/video component like a receiver as shown at 134. The audio/video component, or receiver, may produce one or more separate and discrete channels of full range electrical audio signals which may operate at differing frequency ranges. For example, the receiver 134 shown produces five separate and discrete channels of full range electrical audio signals identified as RR (right rear channel), R (right front channel), C (center channel), L (left front channel) and LR (left rear channel). These audio signal outputs are commonly labelled as simply speaker terminals for the right rear speaker, left rear speaker, center speaker, left front speaker and right front speaker. A commonly known twin lead speaker cable exemplified at 136 may be used to interconnect the output signals, channels or speaker terminals RR, R, C, L, LR from the receiver 134 with the corresponding terminals 106 (RR), 110 (RF), 114 (C), 118 (LF), 120 (LR) on the connecting board 100. Each separate and discrete channel of full range electrical audio signal transmitted by the receiver is received as a separate and discrete channel of full range electrical audio signal by the terminals 106, 110, 114, 118, 120 and then reproduced acoustically and directly from the independent and correspondingly connected speaker systems 98, 92, 94, 90, 96 as a corresponding separate and discrete channel of full range of audio.

In other words, the home theater system 10 incorporates three or more independent speaker systems into a single cabinet for producing three or more separate and discrete channels of audio reproduction. For example, if the receiver transmitted three independent, separate and discrete channels of audio, or signals, (i.e. left front channel, right front channel and center channel) the system 10 would receive these separate and discrete channels or signals and reproduce acoustically and directly from the corresponding independent speaker systems (i.e. left front speaker, right front speaker and center speaker) the corresponding separate and discrete channel of full range audio just as received from the receiver. The system operate under the theory of direct input to direct output for each signal or channel. The speaker systems are not interconnected to one another and do not share components, cross-overs or the like, not do they alter, change, modify, or combine the signal or channel with other portions of a signal or channel in an attempt to simulate separate and discrete channels.

Finally, FIG. 4 provides an example of the audio sound field distribution pattern or flow produced from the home theater system which is shown reproducing acoustically five separate and discrete channels of full range of audio.

The invention has been described in an illustrative manner, and it is to be understood that the terminology, which has been used, is intended to be in the nature of words of description rather than of limitation.

Many modifications and variations of the present invention are possible in light of the above teachings. It is, therefore, to be understood that within the scope of the appended claims, the invention may be practised other than as specifically described.

What is claimed is:

1. A home theater system comprising:
a combination television stand and audio/video equipment cabinet including a support base for supporting said cabinet and a planar top adapted to support a television;
at least three independent speaker systems, each including at least one audio loudspeaker, mounted in said cabinet with each of said speaker systems configured to independently transmit a full range of audio reproduction;
at least three independent speaker terminals mounted to said cabinet, wherein each of said speaker terminals is adapted to receive a separate and discrete channel of full range electrical audio signal transmitted from an amplified audio/video component; and
an audio connector electrically connecting each of said speaker systems with a respective one of said speaker terminals whereby each of said separate and discrete channels of full range electrical audio signal transmitted from the amplified audio/video component is reproduced acoustically and directly from said independent speaker systems as a corresponding separate and discrete channel of full range of audio.

2. The system as set forth in claim 1 wherein said speaker systems include at least a center speaker system, a left speaker system and a right speaker system each configured to independently transmit a full range of audio reproduction and said speaker terminals include at least a center speaker terminal corresponding to said center speaker system, a left speaker terminal corresponding to said left speaker system and a right speaker terminal corresponding to said right speaker system.

3. The system as set forth in claim 2 further including an audio connector electrically connecting said center, left and right speaker terminals independently and directly to said respective center, left and right speaker system whereby a separate and discrete center, left and right channel of full range electrical audio signal transmitted from the amplified audio/video component is reproduced acoustically and directly from said respective independent center, left and right speaker system.

4. The system as set forth in claim 3 wherein said cabinet includes spaced apart left and right front panels extending between said support base and said planar top for supporting said respective left and right speaker systems; a center front panel extending between said left and right front panels for supporting said center speaker system; a rear portion; and left and right side panels extending between said rear portion and said respective left and right front panels and interconnecting said support base and said planar top.

5. The system as set forth in claim 4 wherein said speaker systems include a right rear speaker system and a left rear speaker system mounted to said rear portion of said cabinet adjacent said respective right and left side panel and configured to transmit a full range of audio reproduction.

6. The system as set forth in claim 5 wherein said speaker terminals include a left rear speaker terminal corresponding to said left rear speaker system and a right rear speaker terminal corresponding to said right rear speaker system.

7. The system as set forth in claim 6 further including an audio connector electrically connecting said left rear and right rear speaker terminals independently and directly to said respective left rear and right rear speaker terminals whereby at least one separate and discrete rear channel of full range electrical audio signal transmitted from the amplified audio/video component is reproduced acoustically and directly from said left rear and right rear speaker systems.

8. The system as set forth in claim 7 wherein said cabinet further includes a left and right inner side panels extending parallel to said respective left and right side panels between said center front panel, rear portion, support base and planar top and spaced from said side panels by said left and right front panels to define a cavity therebetween.

9. The system as set forth in claim 8 wherein said cabinet further includes a central opening defined between said left and right inner panels, said support base and said center front panel for receiving and storing one or more of the amplified audio/video components.

10. The system as set forth in claim 9 wherein said cabinet further includes outwardly angled rear corner panels extending between said left and right side panels and said respective left and right inner side panels for supporting said left and right rear speaker systems and transmitting a predetermined direction of audio from said rear speaker systems.

11. The system as set forth in claim 10 wherein said left and right front panels angle outwardly with respect to said central opening and said center front panel tilts upwardly with respect to said planar top for transmitting a predetermined direction of audio from said respective left, right and center speaker systems.

12. The system as set forth in claim 11 further including a woofer speaker mounted to each of said left and right side panels.

13. The system as set forth in claim 12 further including a plurality of porous speaker grills removably attachable to said cabinet for covering each of said speaker systems.

14. The system as set forth in claim 13 further including at least one planar shelf adjustably attachable between said left and right inner side panels within said central opening for supporting one or more of the amplified audio/video components.

15. A home theater system comprising:
a combination television stand and audio/video equipment cabinet including a support base for supporting said cabinet and a planar top adapted to support a television;
at least three independent speaker systems, each including at least one audio speaker driver mounted in said cabinet with each of said speaker systems configured to independently transmit a predetermined range of audio reproduction;
at least three independent speaker terminals mounted to said cabinet, wherein each of said speaker terminals is adapted to receive a separate and discrete channel of an electrical audio signal transmitted from an amplified audio/video component; and
a speaker connector electrically connecting said speaker systems with a respective one of said speaker terminals whereby each of said separate and discrete channels of electrical audio signal transmitted from the amplified audio/video component is reproduced acoustically and directly from said independent speaker systems as a corresponding separate and discrete predetermined range of audio.

16. The system as set forth in claim 15 wherein said speaker systems include at least a center speaker system, a left speaker system and a right speaker system each configured to independently transmit a predetermined range of audio reproduction and said speaker terminals include at least a center speaker terminal corresponding to said center speaker system, a left speaker terminal corresponding to said left speaker system and right speaker terminal corresponding to said right speaker system.

17. The system as set forth in claim 16 further including an audio connector electrically connecting said center, left and right speaker terminals independently and directly to said respective center, left and right speaker system whereby a separate and discrete center, left and right channel of an electrical audio signal transmitted from the amplified audio/video component is reproduced acoustically and directly from said respective independent center, left and right speaker system.

18. The system as set forth in claim 17 wherein said speaker systems include a right rear speaker system and a left rear speaker system mounted to said cabinet and configured to transmit a predetermined range of audio reproduction.

19. The system as set forth in claim 18 wherein said speaker terminals include a left rear speaker terminal corresponding to said left rear speaker system and a right rear speaker terminal corresponding to said right rear speaker system.

20. The system as set forth in claim 19 further including an audio connector electrically connecting said left rear and right rear speaker terminals independently and directly to said respective left rear and right rear speaker terminal whereby at least one separate and discrete rear channel of an electrical audio signal transmitted from the amplified audio/video component is reproduced in a predetermined range of acoustic output directly from said left rear and right rear speaker systems.
